(19) United States
(12) Patent Application Publication
(10) Pub. No.: US 2002/0036649 A1
(43) Pub. Date: Mar. 28, 2002

(54) Apparatus and method for furnishing augmented-reality graphic using panoramic image with supporting multiuser

(76) Inventors: Ju-Wan Kim, Taejon (KR); Chan-Yong Park, Taejon (KR); Byung-Tae Jang, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/953,012

(22) Filed: Sep. 13, 2001

(30) Foreign Application Priority Data
Sep. 28, 2000 (KR) 2000-56983

(51) Int. Cl. H04N 5/253; G09G 5/00

(52) U.S. Cl. 345/633; 348/100; 707/104.1

(57) ABSTRACT

The present invention relates to an apparatus and method for furnishing augmented-reality graphic using panoramic image with supporting multi-user. The apparatus for augmented-reality graphic includes: a panoramic image generation means for generating a panoramic images based on photographed images inputted from a plurality of cameras, generates a panoramic image; a tracker process means for receiving information on a region a vision line of a user is directed to, and generating data of yaw, roll and pitch; a first storage means for storing the panoramic image; an image extraction means for receiving coordinates corresponding to the vision line of the user of the stored panoramic image from the tracker process means, and cliping out the corresponding region of the panoramic image; a second storage means for receiving value added information on the images photographed with the plurality of the cameras, and building up a database; a virtual image generation means for receiving the coordinates corresponding to the vision line of the user from the tracker process means by making use of the database, and generating a virtual image of the corresponding region; an image combining means for combining the clipped panoramic image with the generated virtual image, and generating an augmented-reality graphic; and an output means for displaying the augmented-reality graphic.

### FIELD OF THE INVENTION

The present invention relates to an apparatus and a method for furnishing augmented-reality graphic using a panoramic image with supporting multi-user; and, more particularly, to an apparatus and a method allowing each one of a number of users to see different regions of a panoramic image based on augmented-reality where photographed real pictures are combined with computer-generated virtual images. Also, it is related to a computer-readable record media wherein a program for realizing the method is recorded.

### DESCRIPTION OF THE PRIOR ART

Derived from the technique of virtual-reality, augmented-reality advances the knowledge on the real world. Different from virtual reality, in augmented-reality, the real world information-that is, augmented information-which was already built up is displayed overlapped on the real world image actually observed through a special interface and makes an observer acknowledge the conditions of the object region of the real world quickly and conveniently by interacting with the actual world.

So far only a simple type of information offer has been made, images of a remote place being taken with a camera and outputted on a monitor. Individual users were able to see only what a camera sees and it was difficult to meet various requirements from a number of users who wants to see different regions they are interested in. That is, there was a drawback of providing the identical images only to one or a number of users.

Also, simply showing real picture images taken with a camera, there was another drawback of having to search for data and to make extra survey for additional information on the topography or buildings of the real picture.

### SUMMARY OF THE INVENTION

It is, therefore, an object of the present invention to provide an apparatus and method allowing each user to see different regions of a panoramic image based on augmented-reality where photographed real pictures are combined with computer-generated virtual images, also providing a computer-based record media wherein a program for realizing the method is recorded.

In accordance with an embodiment of the present invention, there is provided an apparatus for augmented-reality graphic, comprising: a panoramic image generation unit that, with photographed images inputted from a plurality of cameras, generates a panoramic image; a tracker process unit that receives information on the region the vision line of a user is directed to, and generates data of yaw, roll and pitch; a first storage unit storing the generated panoramic image; an image extraction unit which receives the coordinates corresponding to the vision line of a user of the stored panoramic image from the tracker process unit, and clips out the corresponding region of the panoramic image; a second storage unit which is provided with additional information on the real pictures photographed with a plurality of cameras, and builds up a database accordingly; a virtual image generation unit which receives the coordinates corresponding to the vision line of a user from the tracker process unit by making use of the database, and generates a virtual image of the corresponding region; an image combining unit which combines the clipped panoramic image with the generated virtual image, and generates augmented-reality graphic; and an output unit which displays the generated augmented-reality graphic.

### BRIEF DESCRIPTION OF THE DRAWINGS

Other objects and aspects of the invention will become apparent from the following description of the embodiments with reference to the accompanying drawings, in which:

FIG. 1 is a block diagram of an embodiment of an apparatus for furnishing augmented-reality graphic in accordance with the present invention;

FIG. 2 is a flow chart of an embodiment of a method for furnishing augmented-reality graphic in accordance with the present invention;

FIG. 3 is a diagram showing how to illustrate an example in a system for furnishing a panoramic image the present invention is applied to; and

FIGS. 4A to 4C illustrate panoramic images for multiple users in accordance with an embodiment of the present invention.

### DETAILED DESCRIPTION OF THE PREFERRED EMBODIMENTS

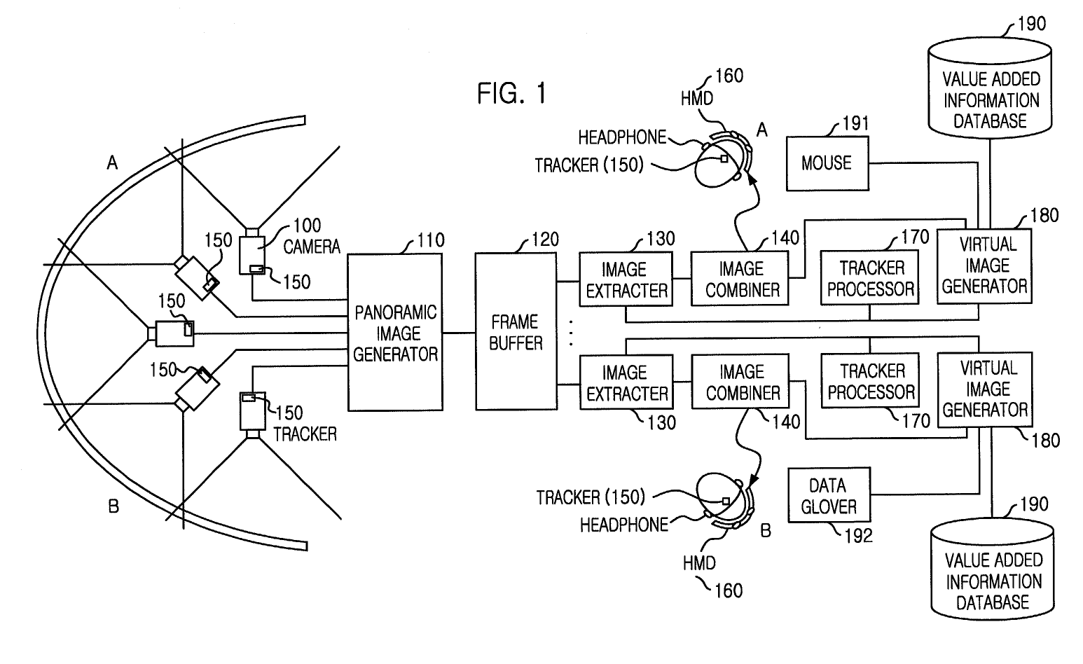

FIG. 1 is a block diagram of an embodiment of the present invention.

The figure shows the overall system of the apparatus for furnishing augmented-reality graphic in accordance with the present invention. That is, each of a plurality of cameras 100 is installed so that a part of its view region overlapped with that of the adjacent camera in order to produce a panoramic image by mosaicking images obtained with each camera. Images obtained with the cameras are inputted to a panoramic image generator 110, made into one panoramic image and stored in a frame buffer 120.

An image extractor 130 assigned to each user receives a vision line direction of a user wearing HMD (head Mounted Display), namely data of yaw, roll and pitch, from a tracker processor 170, and calculates for a region on the panoramic image corresponding to the data. Then the frame buffer 120 clips out the image information in the user's vision angle and send it to an image-combiner 140.

According to the vision line direction of a user, a virtual image generator 180 generates additional information, i.e., letters, graphics, sounds with computer graphic skill and inputs them to the image-combiner 140 along with the images inputted from an image extractor 130 by using value added information database on real image, which has already been built up. The image combiner 140 overlaps the value added information with the two inputted images and the combined image are inputted to a HMD the user is wearing.

As a result, the user can see both images of where his vision line is directed and the value added information thereof. If the user turns his head and looks at another region, the user can get to see images corresponding to the direction of his vision line. Also, in case the user wants more detailed information of the image he is watching, all he has to do is just choose the displayed image by using interface apparatuses such as data gloves 192, virtual image generators 180 and a mouse 191. Then more detailed information on the chosen topography or building is loaded from the value added information database 190, generated into forms of letters, voices and graphics, and then displayed on the user's HMD 160. The user can watch more various forms of additional information independently of what other users watch.

Attached on moving objects, a plurality of the cameras makes move, and when they conduct the above operation they need information about the location and pose of the moving objects to create virtual information. The location information can be obtained by attaching on the objects trackers capable of positioning and figuring out poses such as GPS and Gyro. Here, it's possible to obtain location and pose information of a plurality of the cameras with just one tracker.

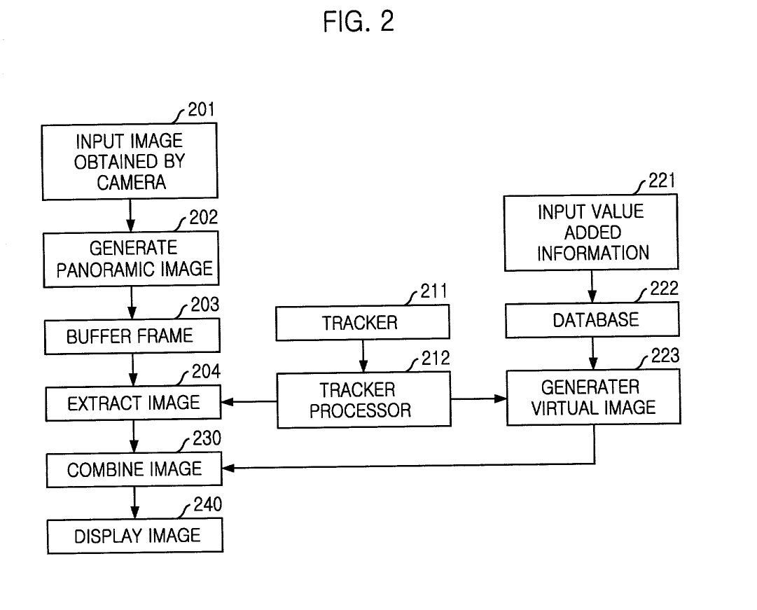

FIG. 2 is a flow chart of an embodiment of a method for furnishing augmented-reality graphic in accordance with the present invention.

Since the method for furnishing augumented-reality graphic is illustrated with reference to FIG. 1, depicting the flow of an embodiment of FIG. 1 for easy description, detailed description for the method will be skipped.

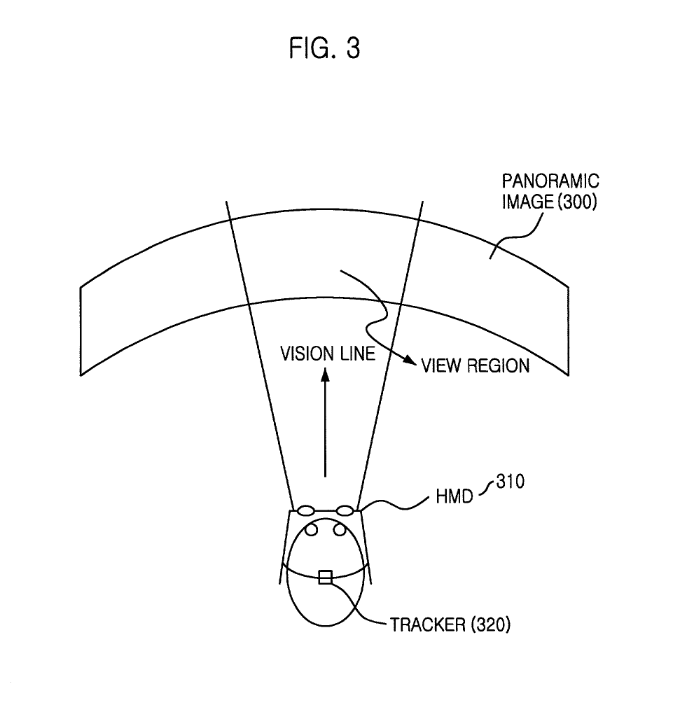

FIG. 3 is a diagram showing how to illustrate an example in a system for furnishing a panoramic image the present invention is applied to.

The figure illustrates how images are shown in panoramic images in accordance with where user's vision line is directed. The HMD 310 the user is wearing can display only part of the panoramic image 300 of wide vision angle.

Referring to FIG. 3, when assumed that the panoramic image is surrounding the user in the front, the HMD 310 displays the region that matches the direction of the user's vision line from the tracker 320 the user is wearing.

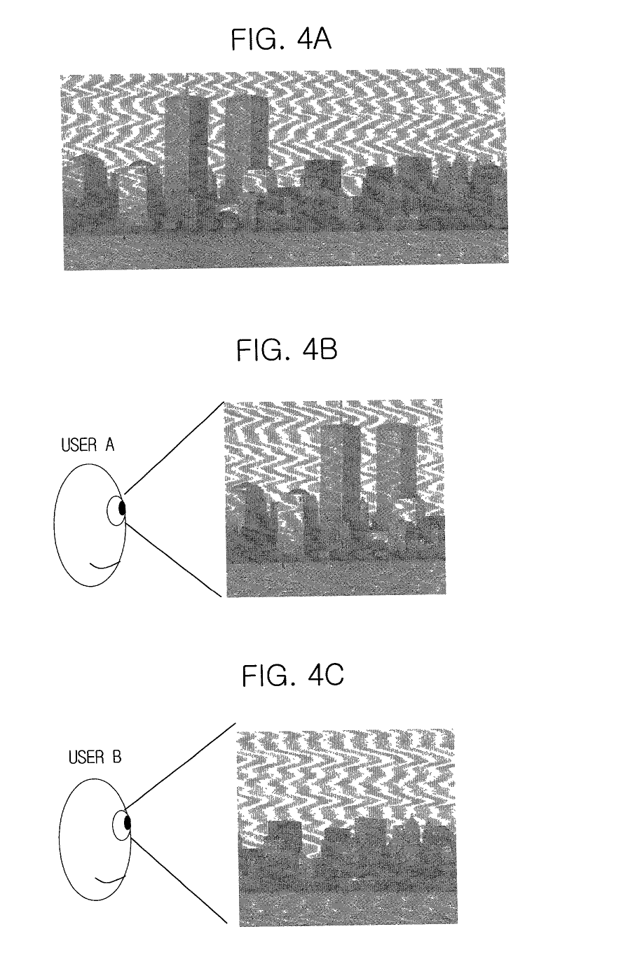

FIGS. 4A to 4C illustrate panoramic images for multiple users of the present invention.

FIGS. 4A to 4C are examples of a display image actually provided to a user in accordance with the present invention. FIG. 4A is a panoramic image obtained with a plurality of cameras, and FIGS. 4B and 4C are images two users are watching. With different interests, two users are watching two different regions, each image of which is shown by extracting the vision line value of each user who is looking at a different region, and clipping out the image of the region corresponding to the direction of each user's vision line. The two images are outputted overlapped with value added information of the real image such as the name of buildings, i.e., hotel, city hall, trade center, etc.

The present invention described above allows a number of users to see a certain region they are interested in from a panoramic image with wide view range at the same time it allows us to see a real picture image overlapped with its information related using a computer, thus making it widely applicable to areas such as tourism, presentation, remote control exploration and so on.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for furnishing augmented-reality graphics, comprising:
a panoramic image generation means for generating a panoramic images based on photographed images inputted from a plurality of cameras, generates a panoramic image;
a tracker process means for receiving information on a region a vision line of a user is directed to, and generating data of yaw, roll and pitch;
a first storage means for storing the panoramic image;
an image extraction means for receiving coordinates corresponding to the vision line of the user of the stored panoramic image from the tracker process means, and cliping out the corresponding region of the panoramic image;
a second storage means for receiving value added information on the images photographed with the plurality of the cameras, and building up a database;
a virtual image generation means for receiving the coordinates corresponding to the vision line of the user from the tracker process means by making use of the database, and generating a virtual image of the corresponding region;
an image combining means for combining the clipped panoramic image with the generated virtual image, and generating an augmented-reality graphic; and
an output means for displaying the augmented-reality graphic.

2. The apparatus as recited in claim 1, wherein the output means is an HMD (Head Mounted Display) with a tracker sending vision line information of the user to the tracker process means.

3. The apparatus as recited in claim 1, wherein, if a number of cameras attached on moving objects move, the tracker process means receives detailed information and locations of the moving objects from the trackers attached thereon, generates data of yaw, roll and pitch and sends standard coordinates information varying as the location and poses of the cameras to the virtual image generation means.

4. A method for furnishing augmented-reality graphics, comprising the steps of:
a) generating a panoramic image based on images taken with a number of cameras;
b) generating data of a user's vision line based on information of a user's vision line;
c) storing the panoramic image;
d) clipping a region corresponding to the data of the user's vision line from the stored panoramic image;
e) building up a database storing relations between value added information and the images taken with the number of cameras;
f) generating a virtual image of a region corresponding to the data of the user's vision line by using the database;
g) generating an augmented-reality graphic by combining the virtual image and the clipped panoramic image; and
h) displaying the augmented-reality graphic to the user.

5. A computer readable recording media storing instructions for executing method for furnishing augmented-reality graphics applied to an augmented-reality system, the method comprising the steps of:
a) generating a panoramic image with photographed images from a number of cameras;
b) generating data of yaw, roll and pitch provided with information of the user's vision line direction
c) storing the generated image;
d) clipping a region corresponding to the generated data of the user's vision line from the stored panoramic image;
e) building up a database inputted with additional information for the real picture taken with a number of the cameras;
f) generating a virtual image of a region corresponding to the data of the user's vision line by using the database;
g) generating an augmented-reality graphic combining the virtual image and the clipped panoramic image;
h) displaying the augmented-reality graphic to the user.
